(19) United States
(12) Patent Application Publication
(10) Pub. No.: US 2008/0040356 A1
(43) Pub. Date: Feb. 14, 2008

(54) WEB SITE AUTOMATING TRANSFER OF INTELLECTUAL PROPERTY

(75) Inventor: Wesley W. Whitmyer JR., Stamford, CT (US)

Correspondence Address: ST. ONGE STEWARD JOHNSTON & REENS, LLC, 986 BEDFORD STREET, STAMFORD, CT, 06905-5619, US

(73) Assignee: WhitServe, LLC, Stamford, CT (US)

(21) Appl. No.: 11/845,372

(22) Filed: Aug. 27, 2007

Related U.S. Application Data
(63) Continuation of application No. 09/725,394, filed on Nov. 29, 2000, now abandoned.
Application No. 09/725,394 is a continuation of application No. 09/612,420, filed on Jul. 7, 2000, now abandoned.
(60) Provisional application No. 60/143,092, filed on Jul. 9, 1999.

(51) Int. Cl. G06F 17/00

(52) U.S. Cl. 707/10; 707/E17.032

(57) ABSTRACT

A system for automating the transfer of intellectual property is provided. The system includes a central computer, a client computer, a communications link between the central computer and the Internet, and a communications link between the client computer and the Internet. The system also includes at least one database containing a plurality of information records accessible by the central computer, each data record containing an intellectual property identification number, and at least one database containing a plurality of intellectual property transfer documents accessible by the central computer. Software executing on the central computer receives a property transfer request, generates necessary transfer documents, transmits said transfer documents, receives executed transfer documents, and transmits said executed transfer documents to necessary intellectual property recordation authorities.

### CROSS-REFERENCE TO RELATED APPLICATIONS

This application is a continuation of U.S. patent application Ser. No. 09/725,394, filed Nov. 29, 2000, which is a continuation of U.S. patent application Ser. No. 09/612,420, filed Jul. 7, 2000, which claims the benefit of, under 35 U.S.C. 119 (e), U.S. Provisional Patent Application No. 60/143,092, filed Jul. 7, 1999.

### FIELD OF THE INVENTION

This invention relates to an Internet-based system for preparing the documents used for performing due diligence, transfer, and recording transfer of intellectual properties pursuant to an acquisition, divestiture, merger, IPO, change of name or the like.

### BACKGROUND OF THE INVENTION

Patents, trademarks, domain names, copyrights, and licenses thereof are often the most valuable assets of a business. This is especially true for software and Internet companies which have limited physical resources by design, and which are increasingly pursuing patents for their business methods. Notwithstanding these facts, it is not uncommon for commercial transactions such as, divestitures, mergers, acquisitions, IPOs, name changes or the like (collectively “transfers”) to proceed either with incorrect schedules of intellectual property, or without any recordation of the transfers with the appropriate intellectual property offices around the world. When companies finally do get around to recording these transfers, it can be very difficult and expensive to root out the proper chain of transactions for recording, especially when one or more companies in the chain is out of business, its records destroyed and its officers unavailable to execute the appropriate papers. In many cases, transfers are not recorded until filing of a lawsuit to enforce the rights since recordation can provide prima facie proof of ownership or may be a necessary prerequisite.

One of the reasons transfers take place with incorrect data, or are not recorded, is that companies may own properties handled by numerous law firms each of which is undergoing its own mergers, acquisitions and divestitures, each of which is probably using a different noncompatible tracking system for intellectual property requiring rekeying of data, and each of which may have data overlapping that of the other firms in an effort to provide as complete a service as possible. In addition, third party firms and companies compete for payment of annuities and renewals on each of the properties such that companies may unwittingly transfer responsibility for handling the files.

A system automating delivery of professional services for date specific reminders is disclosed in my prior U.S. Pat. No. 5,895,468. A website for inputting data and entering professional service orders for date specific reminders is also disclosed in my prior U.S. Pat. No. 6,049,801.

Perfectlaw™ DocPro™ by Executive Data Systems, Inc, of Coral Gables, Fla. has recently begun offering electronic forms for assembly with client data to automate the preparation, prosecution, issue and maintenance of patents and trademarks. These forms, however, are not available over the web; they are software at the user's site such that they require hardware and software maintenance at the user's site

Internet-based application service providers, so called “ASPs” are known and provide the advantage that hardware and software maintenance and upgrades are centrally managed by a third party and not by each user at its own site. None of these sites, however, provide intellectual property due diligence, transfer or transfer recording services.

What is desired, therefore, is a web-based system for automating the preparation of documents used for recording the worldwide transfer of intellectual properties. In addition, a system for generating portfolios of intellectual properties for use in due diligence or transfer is also desired.

### SUMMARY OF THE INVENTION

It is, accordingly, an object of the invention to provide a system for automating, over the Internet, the transfer of intellectual property.

Another object of the invention is to provide a system for automating, over the Internet, the preparation of documents used for the transfer of intellectual property.

A further object of the invention is to provide a system for automating, over the Internet, the preparation of documents used to perform due diligence for the transfer of intellectual property.

The invention and its particular features and advantages will become more apparent from the following detailed description considered with reference to the accompanying drawings.

### BRIEF DESCRIPTION OF THE DRAWINGS

FIG. 1 is a schematic block diagram depicting a system for automating, over the Internet, the transfer of intellectual properties.

FIG. 2 is a schematic block diagram depicting creation of a database of intellectual properties for transfer with the system of FIG. 1.

### DETAILED DESCRIPTION OF THE INVENTION

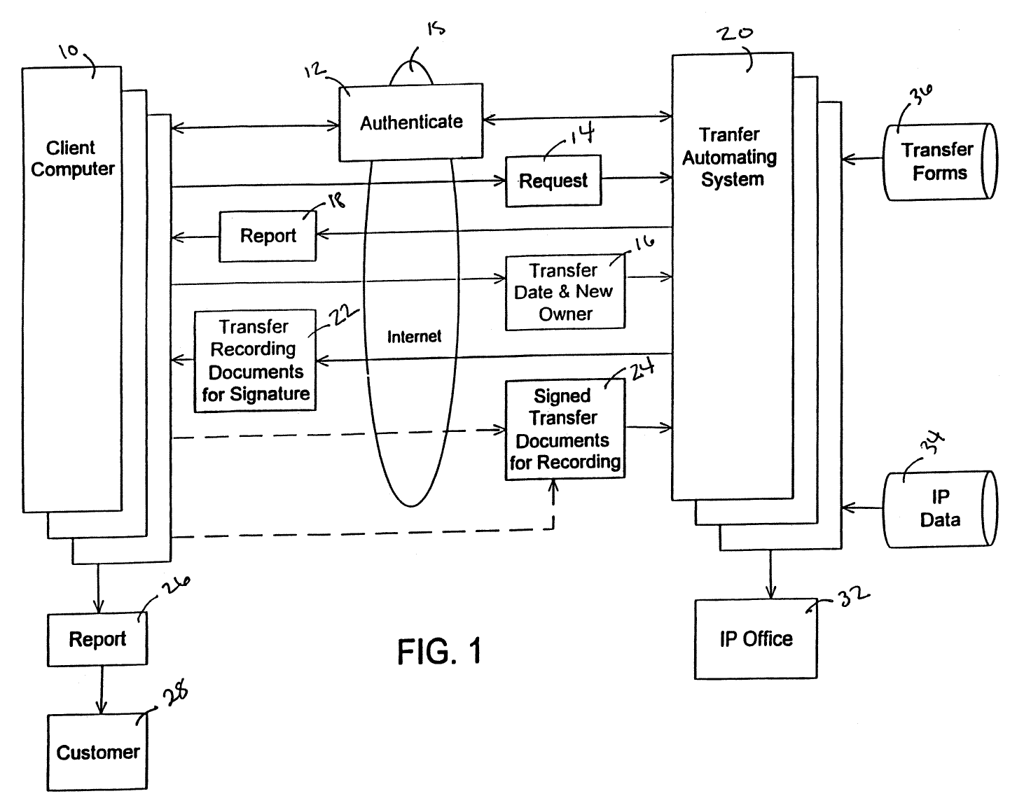

FIG. 1 is a schematic block diagram depicting a system for automating, over the Internet, the transfer of intellectual properties. Using a computer 10, the client initiates communication with the Transfer Automating System (“TAS”) 20 over a communications link, such as the Internet 15, a private network, or a wireless network. The TAS 20 sends a request for authentication 12 to the client 10. The Client 10 submits authentication information 12 to the TAS 20, such as a unique word or phrase, password, biometric identifier, or any authentication identifier known to one skilled in the art. The TAS 20 compares said submitted information to existing TAS records (not shown). If the TAS 20 determines that the client is authentic 12, communication between client computer 10 and TAS 20 is allowed to continue.

When the client 10 elects to transfer intellectual property 14, the TAS 20 transmits a form to the client requesting transaction information necessary to complete said transfer, e.g., intellectual property number, country, date of transfer, and new owner (not shown). Upon receiving said information 16 from the client 10, the TAS 20 queries a database of transfer forms or documents 36 for documents (e.g., recordation forms) necessary to complete said transfer and/or corresponding to the transfer request. In some embodiments, each of the forms includes an intellectual property type identifier and a jurisdiction identifier. The TAS 20 then queries a database of intellectual property information records 34 for information necessary to complete said transfer. Next, the TAS 20 combines said necessary documents with said necessary intellectual property information records and said transaction information (not shown).

The TAS 20 transmits the combined documents 22 to the client 10 by any mechanism known to one skilled in the art, e.g., said communications link, facsimile, etc. The client 10 reviews, edits, and signs documents by electronic signature, traditional writing implement, or any method known to known to one skilled in the art (not shown). The client 10 transmits said signed documents 24 to the TAS 20 by any mechanism known to one skilled in the art, e.g., said communications link, facsimile, etc. In addition, the TAS may repeat this exchange with additional parties where the signatures of said additional parties are necessary to complete the transfer of said intellectual property (not shown).

Upon receipt of said signed documents 24 from the client 10, the TAS 20 may review said signed documents for errors or omissions (not shown). The TAS 20 then transmits said signed documents, by any mechanism known to one skilled in the art, to any intellectual property authority 32 required for the completion of said transfer of intellectual property. In addition, the TAS 20 may also transmit signed documents to third parties at the request of the client (not shown).

The client 10 may also elect to generate a report 18, e.g., details and status of said transfer or intellectual property portfolio. The TAS 20 transmits an information request form to the client (not shown). The client 10 responds to said request 14, including intellectual property identification information such as country, intellectual property number, or owner. The TAS 20 queries databases 34, including third party databases (not shown), based upon said request 14. The TAS 20 transmits said report 18 to the client 10 by any mechanism known to one skilled in the art. The client may forward said report 26 to a third party 28. In addition, the client 10 may request that the TAS 20 send said report directly to a third party (not shown).

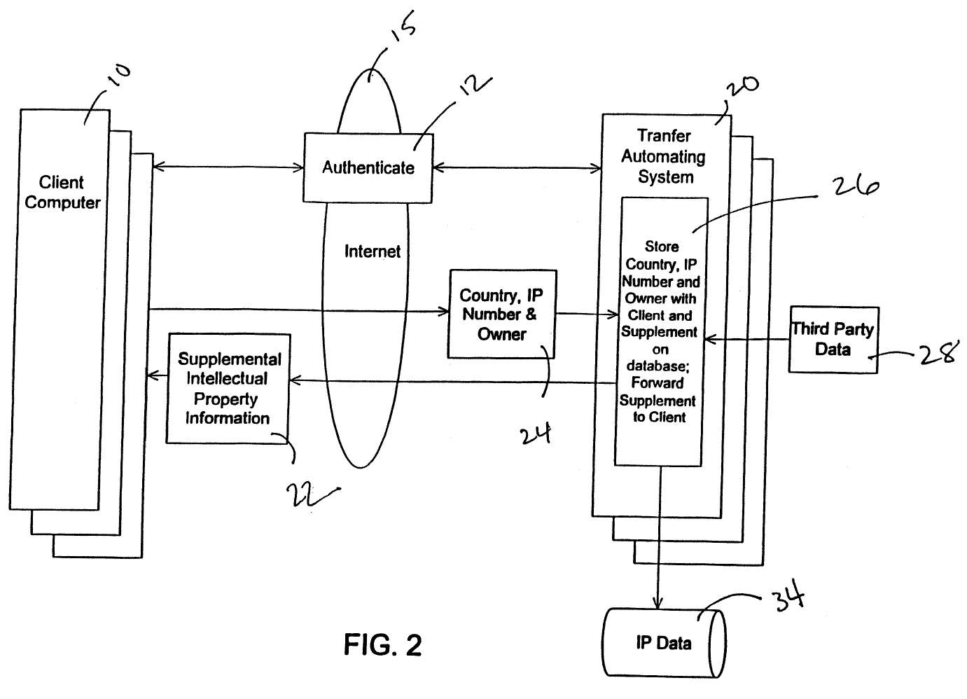

FIG. 2 is a schematic block diagram depicting the creation of a database of intellectual properties information 34 for use with the system of FIG. 1. Information in said database 34 may be inserted and updated by a plurality of mechanisms, e.g., manually entry by a human operator (not shown) or automated entry by the TAS 20 itself using data gathered from multiple sources including third party sources 28.

A client 10 may request information about an intellectual property either during a transfer session with the TAS 20, as described under FIG. 1, or during a separate session initiated by the client 10 for the purpose of obtaining said information. The TAS 20 transmits an information request form to the client (not shown). The client 10 submits intellectual property identification information 24, such as country, intellectual property number, or owner. The TAS 20 queries databases 34, including third party databases 28, based upon said identification information 24. The TAS 20 transmits collected supplemental information 22 to the client 10.

It is to be understood that, although specific embodiments of the invention have been described herein in detail, such description is for purposes of illustration only and modifications may be made thereto by those skilled in the art within the scope of the invention.

What is claimed is:

1. A system for automating the recordation of an assignment of intellectual property comprising:
an Internet server;
a communications link between said Internet server and the Internet;
at least one database containing a plurality of information records accessible by said Internet server, each information record including an intellectual property identification number;
at least one database containing a plurality of assignment forms accessible by said Internet server;
software executing on said Internet server for receiving a transfer request indicative of an assignment of the property; and
software executing on said Internet server for querying said database of information records to retrieve an information record corresponding to a transfer request, for querying said database of recordation forms to retrieve an assignment form corresponding to said transfer request, and for combining the retrieved information record with the retrieved assignment form to generate an assignment document.

2. The system of claim 1 wherein said property is intellectual property selected from the group consisting of patents, copyrights, and trademarks.

3. A system for automating the recordation of an assignment of intellectual property comprising:
an Internet server;
a communications link between said Internet server and the Internet;
at least one database containing a plurality of information records accessible by said Internet server, each information record including an intellectual property identification number, an intellectual property type identifier, and a jurisdiction identifier;
at least one database containing a plurality of assignment forms accessible by said Internet server, each assignment form including an intellectual property type identifier and a jurisdiction identifier;
software executing on said Internet server for generating a property transfer request form indicative of an assignment of the property;
software executing on said Internet server for transmitting said property transfer request form through the Internet;
software executing on said Internet server for receiving a reply to said property transfer request form;
software executing on said Internet server for querying said database of information records to retrieve an information record corresponding to said property transfer request, for querying said database of assignment forms to retrieve an assignment form corresponding to said property transfer request, and for combining the retrieved information record with the retrieved assignment form to generate an assignment document;
software executing on said Internet server for transmitting said assignment document through the Internet; and
software executing on said Internet server for receiving said assignment document though the Internet.

4. The system of claim 3 wherein said property is intellectual property selected from the group consisting of patents, copyrights, and trademarks.

5. The system of claim 3 further comprising of software executing on said Internet server for receiving an executed assignment document.

6. The system of claim 3 further comprising of software executing on said Internet server for transmitting an executed assignment document.

7. The system of claim 3 further comprising of software executing on said Internet server for transmitting said executed assignment document to a property recordation authority.

8. A system for automating the recordation of an assignment of intellectual property comprising:
an Internet server;
a communications link between said Internet server and the Internet;
at least one database containing a plurality of information records accessible by said Internet server, each information record including an intellectual property identification number, an intellectual property type identifier, and a jurisdiction identifier;
at least one database containing a plurality of assignment forms accessible by said Internet server, each assignment form including an intellectual property type identifier and a jurisdiction identifier;
software executing on said Internet server for receiving a transfer request indicative of an assignment of the property;
software executing on said Internet server for querying said database of information records to retrieve an information record corresponding to a transfer request, for querying said database of assignment forms to retrieve an assignment form corresponding to said transfer request, and for combining the retrieved information record with the retrieved assignment form to generate an assignment document;
software executing on said Internet server for transferring said assignment document through the Internet;
software executing on said Internet server for generating a property information request form;
software executing on said Internet server for transmitting said property information request form through the internet;
software executing on said Internet server for receiving a reply to said property transfer request form;
software executing on said Internet server for querying said database of information records to retrieve information records corresponding to said intellectual property information request; and
software executing on said Internet server for updating said database containing a plurality of information records.

9. The system of claim 8 wherein said property is intellectual property selected from the group consisting of patents, copyrights, and trademarks.

10. The system of claim 8 further comprising of software executing on said Internet server for retrieving said updates to said database containing a plurality of information records through the Internet from a plurality of sources.
